(19) United States
(12) Patent Application Publication
(10) Pub. No.: US 2017/0170555 A1
(43) Pub. Date: Jun. 15, 2017

(54) Decoupled Antennas For Wireless Communication

(71) Applicants: TE Connectivity Nederland BV, s'Hertogenbosch (NL); TE Connectivity Germany GmbH, Bensheim (DE)

(72) Inventors: Wijnand Van Gils, Raamsdonksveer (NL); Luc Van Dommelen, Udenhout (NL); Sheng-Gen Pan, Kamp-Lintfort (DE)

(73) Assignees: TE Connectivity Nederland BV, s'Hertogenbosch (NL); TE Connectivity Germany GmbH, Bensheim (DE)

(21) Appl. No.: 15/441,831

(22) Filed: Feb. 24, 2017

Related U.S. Application Data
(63) Continuation of application No. PCT/EP2015/063730, filed on Jun. 18, 2015.

(30) Foreign Application Priority Data
Aug. 25, 2014 (EP) 14182170.2

(51) Int. Cl. H01Q 1/52; H01Q 1/48; H01Q 9/04; H01Q 21/28; H01Q 5/378

(52) U.S. Cl. CPC H01Q 1/521; H01Q 21/28; H01Q 5/378; H01Q 9/0457; H01Q 1/48

(57) ABSTRACT

An antenna assembly is disclosed. The antenna assembly has a first antenna operating at a first frequency and a second antenna operating at a second frequency. The second antenna has a capacitive coupling element and a resonance element. The capacitive coupling element feeds an input signal to the resonance element via capacitive coupling to resonate the resonance element at the second frequency.

### CROSS-REFERENCE TO RELATED APPLICATIONS

This application is a continuation of PCT International Application No. PCT/EP2015/063730, filed on Jun. 18, 2015, which claims priority under 35 U.S.C. §119 to European Patent Application No. 14182170.2, filed on Aug. 25, 2014.

### FIELD OF THE INVENTION

The present invention relates to antennas for wireless communication, and more particularly, to isolation between antennas in multi-antenna devices and systems.

### BACKGROUND

Recent years have seen an increasing demand for multi-frequency antenna structures, such as MIMO (Multiple-Input Multiple-Output) antennas and diversity antennas systems, which can be easily integrated in communication devices of compact size for wireless communication. It is known that the integration of multiple antennas in structures of compact size poses several challenges in antenna circuit design as each antenna element is required to provide a good performance within the frequency band of interest while having a reduced electromagnetic coupling with the other antenna elements. When resonating at the frequency of interest, each antenna element induces an electromagnetic resonance field around itself that may interfere with a resonance field generated by other nearby antenna elements. Further, current distributions may be induced in the ground plane shared by the multiple antennas, in particular around the feed points of the antennas, which also reduce antenna to antenna isolation. Several approaches for reducing the electromagnetic coupling between antennas integrated in a multi-antenna device have been put advanced.

It is well known that the electromagnetic coupling between two antennas decreases with an increase in the separation distance between them. FIG. 1 shows a conventional antenna system 100 having two parallel antenna elements 110 and 120 of the known monopole type, which are arranged at a separation distance dy over a common ground plane 130. The monopole antennas 110 and 120 are mounted on the plastics 160 and 170. Each one of the antenna elements 110 and 120 has its own feed point 140 and 150 for receiving and/or transmitting communication signals from and/or to respective signal feed lines.

An analysis of a port-to-port isolation parameter S21, S12 for each antenna as a function

of frequency provides an indication of the power received at one antenna with respect to the power input to the other antenna, and therefore, the antenna to antenna isolation. As an example, FIG. 2 shows simulation results of the isolation parameter S21 characteristics obtained for the antenna structure 100 at several separation distances dy and for the frequency range 0.5 GHz to 1.0 GHz. As shown in FIG. 2, the isolation parameter S21 decreases with the increase in the separation distance d between monopoles. At a separation distance of dy=40 mm, the isolation parameter S21 reaches a value of about −6dB within the frequency range 0.80 GHz to 0.84 GHz. An isolation value S21 of less than −6 dB is obtained for all frequencies between 0.5 GHz and 1.0 GHz at larger separation distances. In contrast, at separation distances of 30 mm, 20 mm and 10 mm, the values of the isolation parameter S21 are well above −6 dB within the same frequency range. Thus, depending on the dimension limits imposed on the multi-antenna structure and the desired frequency range for communications, the maximization of the separation gap between antenna elements may not be sufficient for achieving the desired antenna to antenna isolation in the frequency range of interest.

FIG. 3 shows another conventional antenna system 300 having a monopole antenna 310 and an inverted L-antenna 320 that share a common ground plane 330. The monopole antenna 310 and the inverted L-antenna 320 are mounted on the plastics 360 and 370. The monopole antenna 310 is directly connected to a feed point 340. The inverted L-antenna 320 is connected to a feed element 350 that includes a shunt inductor for providing good antenna matching and improving antenna to antenna isolation.

FIG. 4 depicts simulation characteristics of the isolation parameters S21 and S12 between the monopole antenna 310 and the inverted L-antenna 320 matched with an ideal shunt inductor for a spacing d between antennas of 40 mm and frequencies between 0.5 GHz and 1.0 GHz. Also represented are simulation characteristics of the return loss parameters S11 and S22 for the monopole antenna 310 and the inverted L-antenna 320, respectively. As shown in FIG. 4, the isolation parameters S12 and S21 reach values of about −6.5 dB at 0.8 GHz. In addition, a frequency band with a return loss parameter S22 of less than −5 dB is obtained for frequencies between 0.789 GHz and 0.817 GHz, which corresponds to a bandwidth of about 29 MHz. Within this frequency range, the return loss parameter S11 is about −6.5 dB. It is very close to −6 dB from the conventional monopole antenna system 100. Moreover, a little improvement of the conventional antenna system 300 in isolation parameters S12 and S21 is partly due to the poor return loss parameters S11 of the antenna system 300. Therefore, the antenna system 300 could not be used to improve the antenna to antenna isolation.

Other techniques based on the addition of the isolation elements have been proposed. For instance, U.S. Pat. No. 7,525,502 B2 describes a method for improving isolation between a main antenna (e.g., a GSM antenna) and a further antenna (e.g., a WLAN antenna) in an electronic communication device by providing a floating parasitic element that is placed between the two antennas for providing an isolation from electro-magnetically coupled currents between these two antennas in a ground plane. The two antennas are connected to the ground plane whereas the parasitic element is floating and electrically isolated from the ground plane. In order to improve isolation in the frequency range of interest, i.e., in the 1900 MHz band, the known method requires that the length of the floating parasitic element be a half wavelength at the frequency of interest. This means using a floating parasitic element of at least 15 cm length for communications at 1 GHz. Thus, this technique compromises the miniaturization of multi-antenna structures, at least for multi-antenna structures intended for operation at frequencies below 1 GHz.

### SUMMARY

An object of the invention, among others, is to provide an antenna assembly having a plurality of antennas with improved antenna to antenna isolation while offering good performance in the frequency bands of interest, and which are compatible with the demand for miniaturization of wireless communication devices. The disclosed antenna assembly has a first antenna operating at a first frequency and a second antenna operating at a second frequency. The second antenna has a capacitive coupling element and a resonance element. The capacitive coupling element feeds an input signal to the resonance element via capacitive coupling to resonate the resonance element at the second frequency.

### BRIEF DESCRIPTION OF THE DRAWINGS

The invention will now be described by way of example with reference to the accompanying figures, of which:

FIG. 1 is a perspective view of a conventional antenna assembly having two monopole antennas;

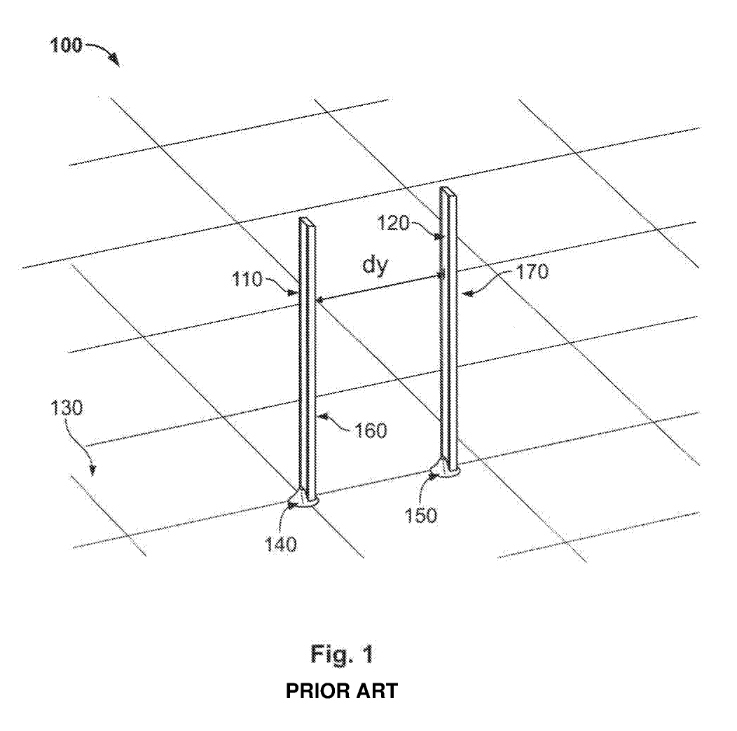

FIG. 2 is a graph of an isolation parameter between the monopole antennas of FIG. 1 for different separation distances between the two monopoles;

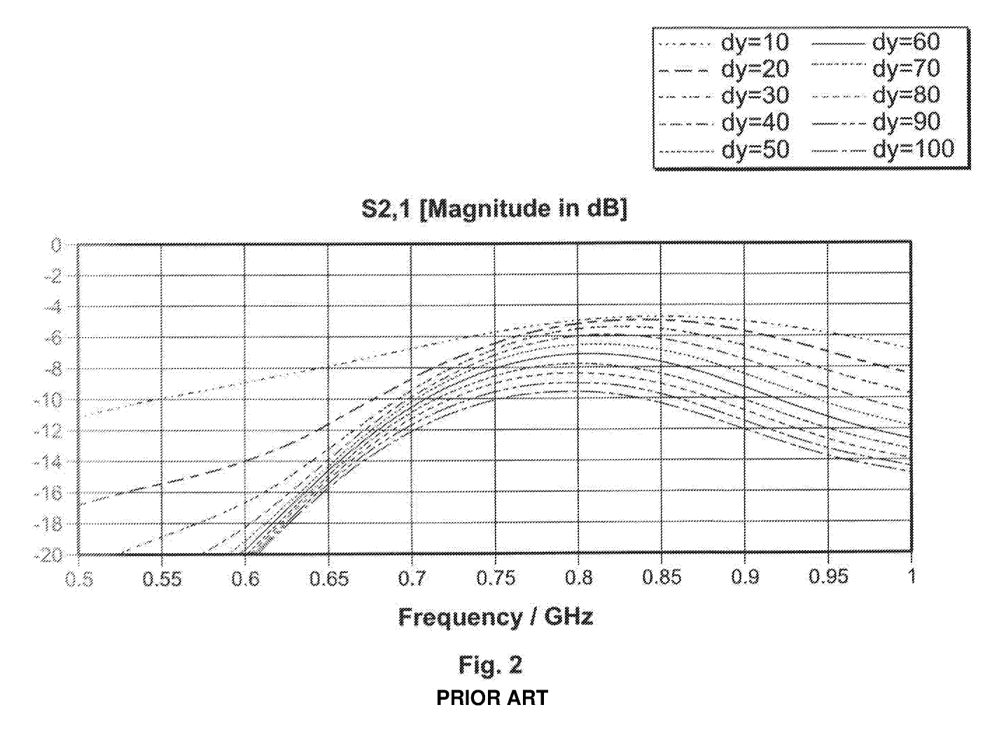

FIG. 3 is a perspective view of another conventional antenna assembly having a monopole antenna and an inverted L-antenna;

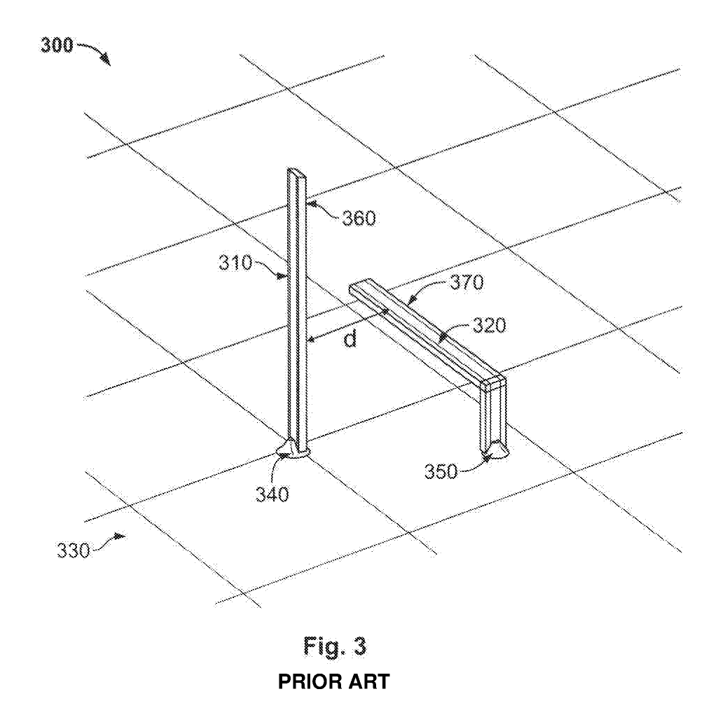

FIG. 4 is a graph of return loss parameters and isolation parameters of the monopole antenna and the inverted L-antenna of FIG. 3;

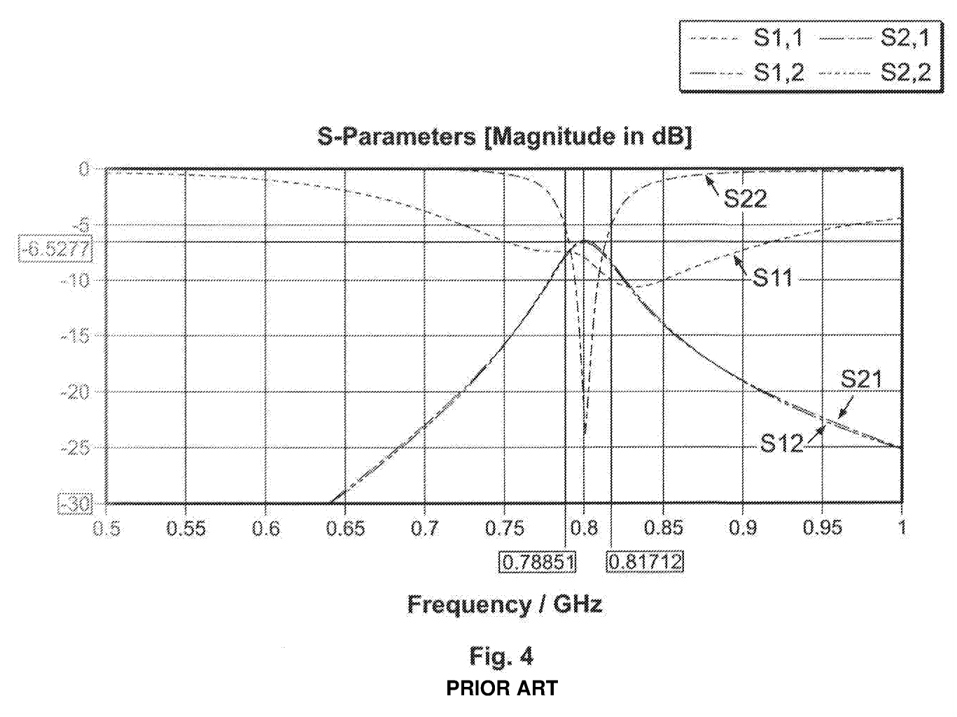

FIG. 5 is a perspective view of an antenna assembly according to an embodiment of the invention;

FIG. 6 is a side view of the antenna assembly of FIG. 5;

FIG. 7 is a graph of return loss parameters and isolation parameters of the antenna assembly of FIG. 5;

FIG. 8 is a perspective view of an antenna assembly according to another embodiment of the invention;

FIG. 9 is a side view of the antenna assembly of FIG. 8; and

FIG. 10 is a graph of return loss parameters and isolation parameters of the antenna assembly of FIG. 8.

### DETAILED DESCRIPTION OF THE EMBODIMENT(S)

The invention is explained in greater detail below with reference to embodiments of an antenna assembly. This invention may, however, be embodied in many different forms and should not be construed as limited to the embodiments set forth herein; rather, these embodiments are provided so that this disclosure will be thorough and complete and still fully convey the scope of the invention to those skilled in the art.

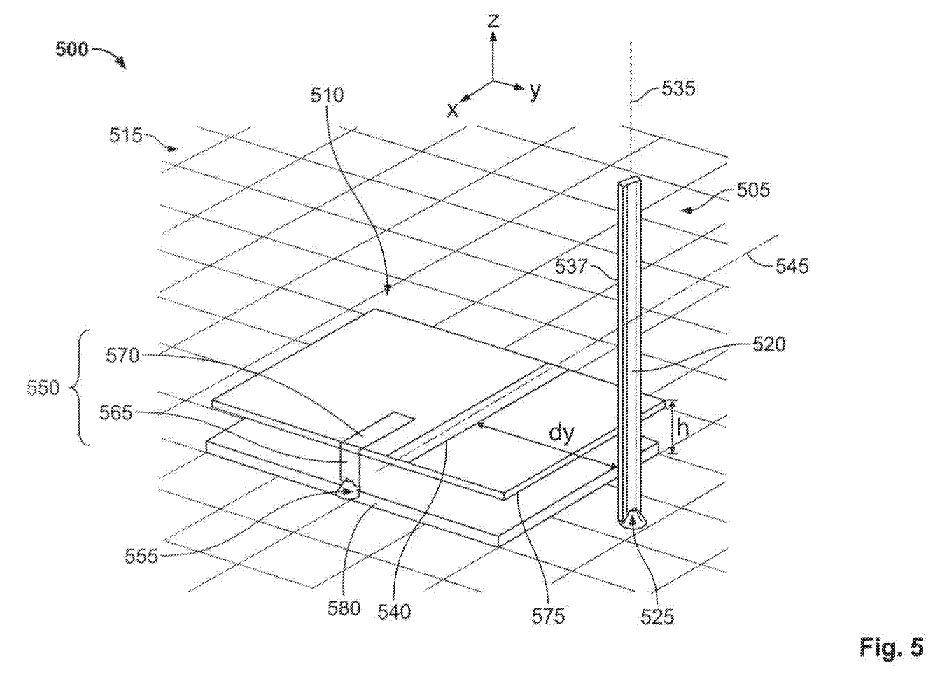

An antenna assembly 500 according to an embodiment of the invention is shown in FIG. 5. The antenna structure 500 comprises a first antenna 505 and a second antenna 510 operable to perform communications at first and second frequencies, respectively. The first and the second frequencies are substantially the same and/or are within a predetermined frequency band for performing wireless communications.

As shown in FIG. 5, the first and second antennas 505, 510 are arranged at a predetermined distance dy on a ground plane 515. The ground plane 515 is represented in FIG. 5 as an infinite ground plane. In practice, the ground plane 515 may form part of a ground substrate, a part of a casing device comprising the antenna assembly 500 or of a vehicle roof in which the assembly 500 is installed, or the like. In the shown embodiment, the first and second antennas 505, 510 are arranged on a same side of the ground plane 515. In other embodiments, the first and the second antennas 505, 510 are provided on separate ground substrates and/or arranged on opposite sides of the ground substrate.

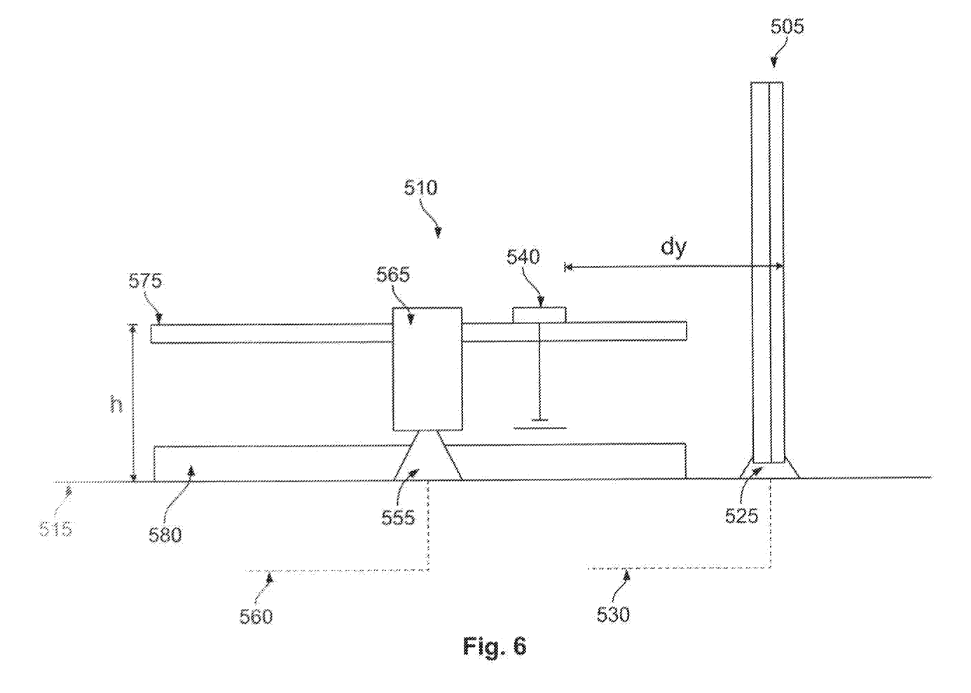

The first antenna 505, as shown in FIGS. 5 and 6, has a resonance element 520 adapted to resonate at the first frequency and/or within a certain bandwidth about the first frequency. The resonance element 520 is electrically connected to a first feed point 525, which provides a direct connection to a first feed transmission line 530 for transmitting communication signals to/from the first antenna 505. The communication signals received from the first feed transmission line 530 for the first antenna 505 are then directly fed to the resonance element 520.

In FIG. 5, the resonance element 520 is a resonance arm that extends upwards from the ground plane 515 along a first axis 535 that is substantially perpendicular to the ground plane 515 (i.e., parallel to the Z-axis shown in FIG. 5). The resonance arm 520 is directly connected to the feed point 525 at an end adjacent the ground plane 515. The resonance arm 520 may be provided as a flat strip of a conductor material, such as a metal, and may be deposited or arranged over a dielectric plate 537 for providing additional support to the resonance element 520. The length and width of the resonance arm 520 are selected based on the desired frequency and/or frequency band for operation of the first antenna 505. For instance, a length of about or a little less than a quarter of the wavelength corresponding to the operation frequency of interest and a width of a few mm may be used. In the shown embodiment, the first antenna 505 is an antenna of a monopole type. However, other types of antennas and with other configurations may be used for the first antenna 505. Further, as it will be immediately realized by those skilled in the art, the resonance element of the first antenna 505 may take forms and shapes other than the resonance arm 520 described above without departing from the principals of the present invention.

The second antenna 510, as shown in FIGS. 5 and 6, comprises a resonance element 540 adapted to resonate at the second frequency and/or within a certain bandwidth about the second frequency, and a capacitive coupling element 550 for establishing a capacitive coupling with the resonance arm 540. The capacitive coupling element 550 is directly connected to a second feed point 555.

Input signals received at the second feed point 555 are then fed to the resonance element 540 via capacitive coupling with the capacitive couple element 550. This creates a resonance on the resonance element 540 at said second frequency while causing reduced interference with the first antenna 505. In the present embodiment, the first and second frequencies are substantially the same and/or within a desired frequency range. However, the first and the second antennas 505 and 510 may be designed so as to resonate at different frequencies without departing from the principles of the present invention.

Referring to FIG. 5, the resonance element 540 is arranged on a plane substantially parallel to the ground plane 515, and at a given height h above the ground plane 515. In the shown embodiment, the resonance element 540 is a resonance arm that extends along a second axis 545 that is substantially parallel to the ground plane (i.e., parallel to the X-axis shown in FIG. 5) and located at a predetermined separation distance dy along the Y-direction from the first antenna resonance element 520. The resonance arm 540 is electrically connected to ground at an end opposite the end adjacent the capacitive coupling element 550.

The capacitive coupling element 550 is arranged in the proximity of the resonance arm 540 and at a predetermined distance therefrom. In the shown embodiment, the capacitive coupling element 550 is a conductor having an inverted L-shape. The capacitive coupling element 550 may be formed from a strip of conductor material that is bent or folded into the inverted L-shape. This inverted L-shape has a non-planar structure having first and second arms 565 and 570 that are connect to each other at substantially a right angle.

As shown in FIG. 5, the capacitive coupling element 550 is disposed close to the second antenna resonance arm 540 such that the second arm 570 of the inverted L-shape is oriented in parallel with the resonance arm 540. The second arm 570 is disposed on the same plane as the resonance arm 540 for improving the capacitive coupling while reducing interference with the first antenna 505. However, other configurations are possible; the capacitive coupling element 550 may be located at a height different from h, i.e., below or above the resonance arm 540.

The first arm 565 of the inverted L-shape extends downward from the second arm 570 towards the ground plane 515 along the vertical direction (i.e., the Z-axis). The second feed point 555 is electrically connected to an end of the first arm 565 that is closer to the ground plane 515. The length of the first arm 565 substantially bridges the vertical gap h between the second arm 570 and the ground plane 515. The length of the first arm 565, as well as the height h of the vertical gap, is varied so as to tune the bandwidth and the capacitive coupling of the second antenna 510.

The dimensions of the first arm 565, the second arm 570 and the horizontal gap between the resonance arm 540 and the capacitive coupling element 550 may be selected so as to provide the desired capacity feed for the second antenna 510 while reducing interference with the first antenna 505. For instance, the length of the second arm 570 may be shorter than the length of the resonance arm 540 of the second antenna 510 so as to ensure that the capacitive coupling element 550 does not resonate at the operation frequencies of the second antenna 510. In the embodiment shown in FIG. 5, the length of the second arm 570 is about a third of the length of the resonance arm 540. The capacitive coupling element 515 has been described as a folded strip with an inverted L-shape, however, the capacitive coupling element 515 may alternatively have other shapes and structures that are suitable for providing a capacitive feed to the second antenna 510.

The resonance arm 540 and the second arm 570 of the capacitive coupling element 550 may be arranged over a dielectric plate 575 for providing additional support, as shown in FIG. 5. In addition, a conducting plate 580 is disposed over the ground plane 515 and below the dielectric plate 575. The feed points 525 and 555 are separated and electrically isolated from the ground plane 515 as well as the conducting plate 580. In the shown embodiment, the dielectric plate 575 and the conducting plate 580 are separated by a vertical air gap. However, other configurations may be envisaged in which the dielectric plate 575 has a thickness that entirely or partially fills the vertical gap h between the ground plane 515 and the resonance arm 540. The dielectric plate 575 and the conducting plate 580 are optional features, and therefore, may be omitted.

As shown in FIG. 6, the first antenna resonance arm 520 and the capacitive coupling element 550 are directly connected to respective feed transmission lines 530 and 560 via the first and second feed points 525 and 555, respectively. The resonance arm 540 of the second antenna 510 is directly connected to ground at an end opposite the end adjacent the capacitive coupling element 550. The capacitive coupling element 550 and the second feed point 555 are disposed at an end of the second antenna resonance arm 540 opposite the end connected to ground. In addition, the capacitive coupling element 550 is disposed on a lateral side of the resonance element 540 opposite the lateral side facing the first antenna 505 so as to avoid electromagnetic coupling between the capacitive coupling element 550 and the first antenna 505. Therefore, the second antenna resonance arm 540 is interposed between the capacitive coupling element 550 and the first antenna 505.

As shown in FIG. 5, the first antenna resonance arm 520 and the second antenna resonance arm 540 lie on different orthogonal planes, and are oriented relative to each other in such a manner that the first axis 535 and second axis 540 do not cross nor overlap each other. In FIG. 5, the second axis 545 of the second antenna 510 is oriented substantially at a right angle with respect to the first axis 535 of the first antenna 505 and in parallel to the flat surface of the first antenna resonance arm 520. In addition, when viewed from the Y-axis, the first antenna resonance arm 520 is arranged at a position along the X-axis that overlaps with the second antenna resonance arm 540 at a part of the resonance arm 540 distant from the capacitive coupling element 550. Such a relative arrangement of the first and second antennas 505, 510 reduces the overall size of the antenna assembly 500 while maximizing the separation between the resonant elements 520, 540.

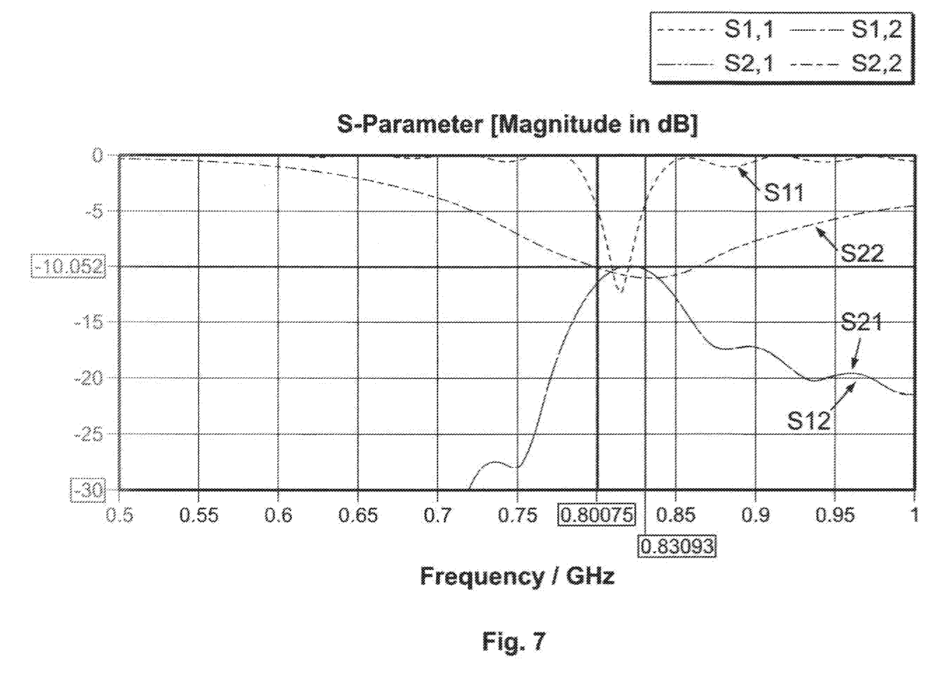

The improvement in antenna to antenna isolation for the antenna assembly 500 is shown in FIG. 7. FIG. 7 shows simulated characteristics of the return loss parameters S11 and S22 of the first antenna 505 and the second antenna 510, respectively, as well as the characteristics of the isolation parameters S21 and S12 between the first antenna 505 and the second antenna 510. These characteristics were obtained for a separation distance of 40 mm between the first and the second antennas 505 and 510. As shown in FIG. 7, within the frequency range 0.80 GHz to 0.83 GHz for which the return loss parameter S22 associated with the second antenna 510 falls below −5 dB, which corresponds to a bandwidth of about 30 MHz, the isolation parameters S12 and S21 are of about −10 dB. The return loss parameter S11 for the first antenna 505 also falls below −10 dB in this frequency range. Thus, the capacitive feed of the second antenna 510 improves isolation between the first and second antennas 505 and 510 by several dBs for a spacing between the two antennas that is much smaller than a quarter of a wavelength at the frequencies of interest (for. e.g., □=375 mm at 0.8 GHz).

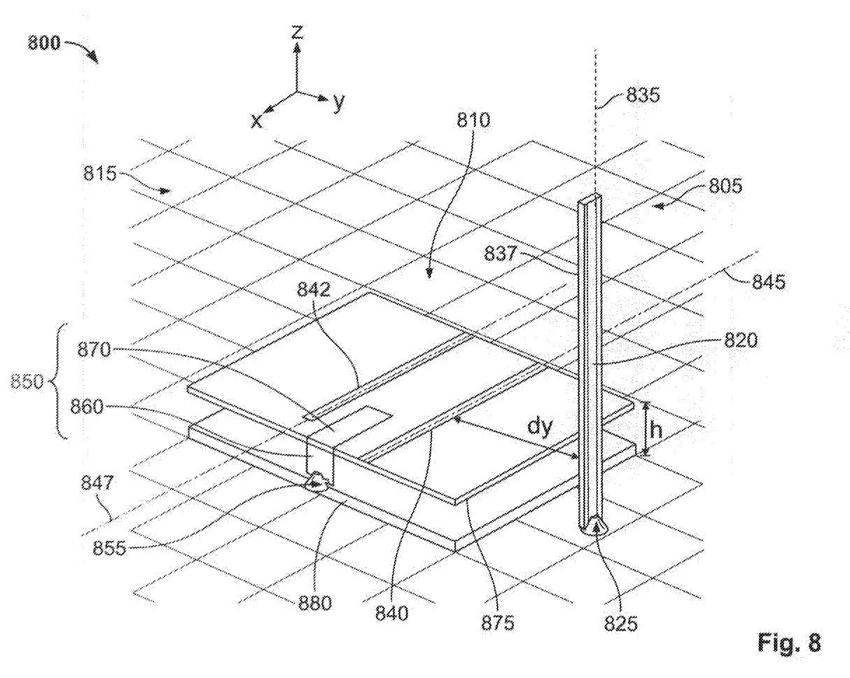

An antenna assembly 800 according to another embodiment of the invention will now be described with reference to FIGS. 8-10. The antenna assembly 800 comprises a first antenna 805 and a second antenna 810 disposed at a predetermined separation distance dy on a ground plane 815. The antenna assembly 800 differs from the antenna assembly 500 in that the second antenna 810 comprises at least two resonance elements 840, 842 adapted to resonate at respective frequencies, as described in greater detail below. The input signals are capacitive fed to both resonance elements 840, 842 of the second antenna 810 for improving isolation between the first and the second antennas 805 and 810.

The first antenna 805 comprises a resonance element 820 for resonating at a given first frequency and/or within a desired frequency range. The resonance element 820 is electrically connected to a first feed point 825, which provides a direct connection to a first transmission line 830 for directly feeding an input communication signal to the resonance element 820. As shown in FIG. 8, the resonance element 820 may be provided as a resonance arm that extends upwards from the ground plane 815 along a first axis 835 that is substantially perpendicular to the ground plane 815 (i.e., parallel to the Z-axis shown in FIG. 8). The resonance arm 820 may be a flat strip of a conductive material, such as a metal, and may be deposited or arranged over a dielectric plate 837. The resonance arm 820 is directly connected to the first feed point 825 at one end. The length and width of the resonance arm 820 are selected based on the desired frequency and/or frequency band for operation of the first antenna 805, e.g. a length of about or a little less than a quarter wavelength and a width of a few mm. As the details of the first antenna 810 are similar to those described above with reference to the first antenna 505, these will not be further repeated hereafter. In the shown embodiment, the first antenna 805 is of monopole type. However, other types of antennas could be used. In particular, the first antenna 805 may include resonance elements having forms and shapes other than those of the resonance arm 820.

The second antenna 810 comprises at least two resonance elements, a first resonance element 840 and a second resonance element 842, which are arranged at a given distance on a same plane substantially parallel to the ground plane 815. The first and second resonance elements 840 and 842 are adapted to resonate at second and third frequencies, respectively. The second and third frequencies are different so that the second antenna 810 is operable as a dual band antenna. However, other configurations of the second antenna 810 may be envisaged in which the resonance elements are adapted to radiate at the same frequency. In an embodiment, the second frequency is the same as the first frequency of the first antenna 805. However, any one of the second and third frequencies may be the same and/or within the same frequency range as the first frequency. Alternatively, the first to third frequencies may all be different.

As shown in FIG. 8, the first resonance element 840 is arranged on a plane substantially parallel to the ground plane 815 and at a given height h above the ground plane 815. In addition, the first resonance element 840 is positioned at a predetermined distance dy along the Y-direction from the resonance element 820 of the first antenna 805.

The first and second resonance elements 840 and 842 may be provided as resonance arms of respective lengths that extend along a second axis 845 and a third axis 847, respectively, substantially parallel to the ground plane 815 (i.e., parallel to the X-axis). The resonance arms 840 and 842 may have different lengths, which are selected so as to produce resonances at different second and third frequencies, respectively. In FIG. 8, the second resonance arm 842 is shorter than the first resonance arm 840 so as to provide a resonance frequency higher than the resonance frequency of the first resonance arm 840. In the shown embodiment, the first and second resonance arms 840 and 842 are co-planar and substantially parallel to each other. However, in other embodiments, the first and second resonance elements 840, 842 of the second antenna 810 lie on different planes at different heights with respect to the ground plane 815, and/or are aligned along axes that are not parallel to each other.

The second antenna 810 further includes a capacitive coupling element 850 for feeding, via capacitive coupling, input signals to the first and second resonance elements 840 and 842 so as to create resonances at the respective second and third frequencies, respectively. Similarly to the first embodiment, the capacitive coupling element 850 may be provided as a conductor having an inverted L-shape with first and second arms 865 and 870. As the details of the inverted-L shape are similar to those described with reference to the first embodiment, these will not be repeated hereafter.

As shown in FIG. 8, the capacitive coupling element 850 is arranged at an intermediate location between the resonance elements 840 and 842 with respective separation gaps so as to establish a good capacitive coupling with both resonance elements 840 and 842. The capacitive coupling element 850 is arranged between ends of the first and second resonance arms 840 and 842. At the opposite ends, the first and second resonance arms 840 and 842 are electrically connected to ground. The dimensions of the first and second arms 865 and 870 as well as the separation distances between the capacitive coupling element 850 may be adjusted so as to provide the desired capacitive feed to both resonance elements 840 and 842. The resonance elements 840 and 842 may have a length of about or a little less than a quarter of the wavelength corresponding to the respective operation frequencies and a width of a few mm.

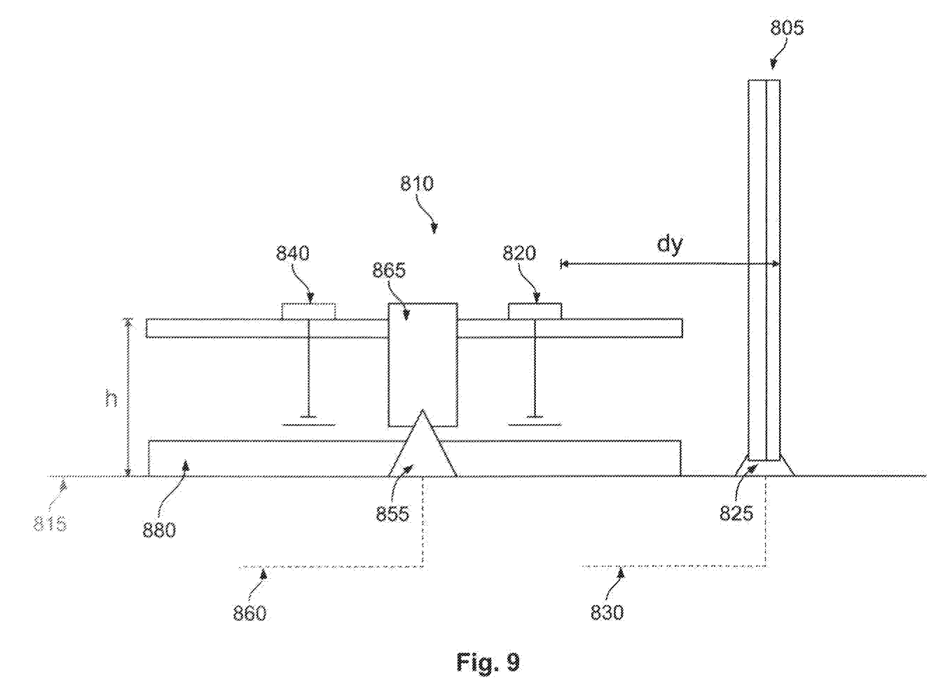

As shown in FIG. 9, the resonance element 820 of the first antenna 805 and the capacitive coupling element 850 are directly coupled to feed transmission lines 830 and 860 via the first and second feed points 825 and 855, respectively. As in the first embodiment, the feed points 825 and 855 are not electrically connected to the ground plane. The first and second resonance elements 840 and 842 of the second antenna 810 are electrically connected to ground. The relative orientation between the first resonance element 840 of the second antenna 810 and the resonance element 820 of the first antenna 805 is similar to the orientation described with reference to the resonance elements 540 and 520 of first embodiment, and, therefore, will not be further detailed here.

The second arm 870 of the capacitive coupling element 850 and the resonance arms 840 and 842 may be arranged over a dielectric plate 875 for providing additional support, as shown in FIG. 8. A conducting plate 880 may also be provided over the ground plane 815 and below the dielectric plate 875. The feed points 825 and 855 are separated and electrically isolated from the ground plane 815 as well as the conducting plate 880. However, the dielectric plate 875 and the conducting plate 880 are optional features, and therefore, may be omitted.

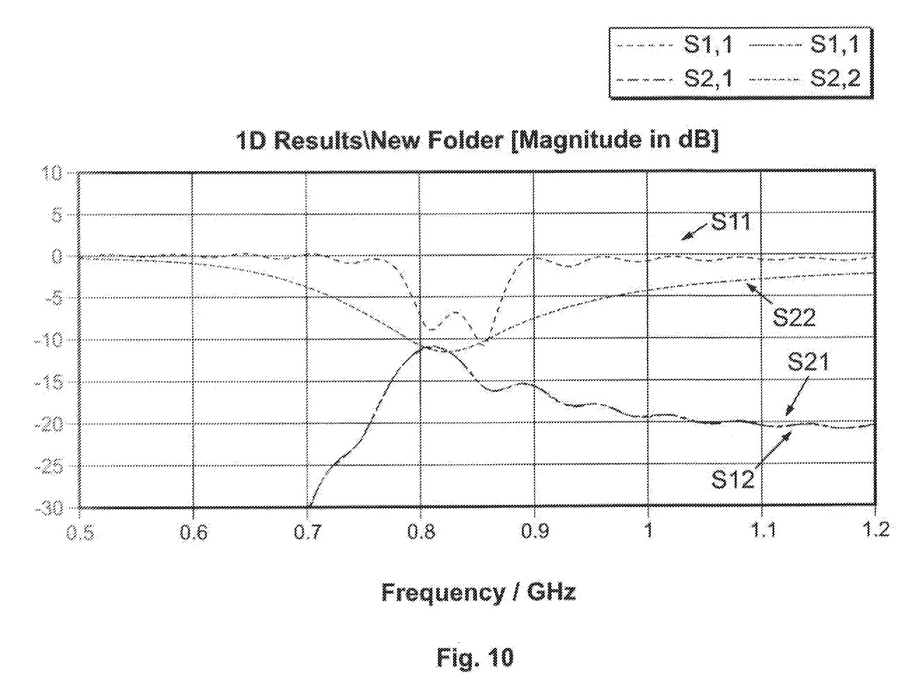

An analysis of the antenna to antenna isolation achieved for the antenna assembly 800 is shown in FIG. 10. FIG. 10 shows characteristics of the return loss parameters S11 and S22 of the first and second antennas 805 and 810, respectively, as well as characteristics of the isolation parameters S21 and S12 between the first antenna 805 and second antenna 810. These characteristics were obtained for a separation distance, dy, of 40 mm. As shown in FIG. 10, isolation parameters S12 and S21 of about −10 dB are obtained at a frequency of about 0.81 GHz. The return loss characteristic S11 of the second antenna 810 shows two nearby resonances corresponding to the resonances of the resonance elements 840 and 842, which are responsible for the broadening of the frequency band of interest. The return loss parameter S22 for the second antenna 810 is less than −5 dB for a bandwidth of 80 MHz. Thus, although the antenna assembly 800 includes three resonant elements in total, the capacitive feed of the second antenna 810 still achieves a good isolation between the first and second antennas 805 and 810.

Thus, by providing a multi-antenna assembly in which input signals for at least one of the antennas is fed by capacitive coupling, the present invention reduces electromagnetic interference between antennas, namely, at a separation between antennas much less than a quarter of a wavelength at the frequencies of interest. Thus, antenna to antenna isolation may be improved while still providing antenna assemblies of a small form factor.

Although the above embodiments are described with reference to antenna assemblies having two antennas, the principles of the present invention may also be applied to multi-antenna assemblies having more than two antennas and in which at least one of the antennas is capacitively coupled to a feed line according to the principles of the present invention. Further, one or more antennas of the plurality of antennas may be of types other than monopole antennas. Finally, the present invention has been described using terms as “vertical”, “horizontal”, “upwards”, and the like. As it will be readily recognized by those skilled in the art, such terms are not intended to limit the use or construction of the antenna assembly and its components to a specific direction, for e.g. a vertical direction, but are used as relative terms for defining the relative orientation between components of the antennas and/or with respect to the ground plane.

What is claimed is:

1. An antenna assembly, comprising:
a first antenna operating at a first frequency; and
a second antenna operating at a second frequency and having a capacitive coupling element and a resonance element, the capacitive coupling element feeding an input signal to the resonance element via capacitive coupling to resonate the resonance element at the second frequency.

2. The antenna assembly of claim 1, further comprising a ground plane.

3. The antenna assembly of claim 2, wherein the first antenna has a resonance element resonating at the first frequency, the resonance element of the first antenna electrically connected to a first feed point.

4. The antenna assembly of claim 1, wherein the first frequency and the second frequency are substantially the same.

5. The antenna assembly of claim 1, wherein the first frequency and the second frequency are within a predetermined wireless communication frequency band.

6. The antenna assembly of claim 3, wherein the resonance element of the second antenna is electrically connected to the ground plane and the capacitive coupling element is electrically connected to a second feed point.

7. The antenna assembly of claim 6, wherein the resonance element of the first antenna and the resonance element of the second antenna are disposed on different planes substantially perpendicular to each other.

8. The antenna assembly of claim 6, wherein the resonance element of the first antenna includes a first resonance arm extending along a first axis substantially perpendicular to the ground plane.

9. The antenna assembly of claim 6, wherein the resonance element of the second antenna includes a second resonance arm extending along a second axis substantially parallel to the ground plane.

10. The antenna assembly of claim 9, wherein the capacitive coupling element is a conductor having an inverted L-shape with a first arm and a second arm, the first arm substantially perpendicular to the second arm.

11. The antenna assembly of claim 10, wherein the capacitive coupling element is disposed such that the second arm of the capacitive coupling element is substantially parallel to the second resonance arm.

12. The antenna assembly of claim 11, wherein the second arm of the capacitive coupling element and the second resonance arm are not disposed along a common axis.

13. The antenna assembly of claim 12, wherein the second arm of the capacitive coupling element has a length such that the second arm does not resonate at the second frequency.

14. The antenna assembly of claim 1, wherein the first antenna, the capacitive coupling element, and the resonance element of the second antenna are disposed side by side and spaced apart.

15. The antenna assembly of claim 14, wherein the resonance element of the second antenna is disposed between the capacitive coupling element and the first antenna.

16. An antenna assembly, comprising:
a first antenna operating at a first frequency; and
a second antenna having a first resonance element resonating at a second frequency, a second resonance element resonating at a third frequency, and a capacitive coupling element capacitively coupled to the first resonance element and the second resonance element.

17. The antenna assembly of claim 16, wherein the capacitive coupling element feeds an input signal to each of the first and second resonance elements of the second antenna via capacitive coupling to resonate the first resonance element at the second frequency and the second resonance element at the third frequency.

18. The antenna assembly of claim 17, wherein the third frequency is different from the second frequency such that the second antenna is operable as a dual-band antenna.

19. The antenna assembly of claim 18, wherein the second resonance element of the second antenna extends substantially parallel to the first resonance element of the second antenna.

20. The antenna assembly of claim 19, wherein the capacitive coupling element is disposed between the first and second resonance elements of the second antenna.
